(19) United States
(12) Patent Application Publication
(10) Pub. No.: US 2005/0222762 A1
(43) Pub. Date: Oct. 6, 2005

(54) Method and system for automated incident traffic reporting and dynamic routing

(75) Inventors: Rick Allen Hamilton, Charlottesville, VA (US); Michael Edward Schwartz, Gaithersburg, MD (US); James Wesley Seaman, Falls Church, VA (US); Timothy Moffett Waters, Richmond, VA (US)

Correspondence Address: Gregory W. Carr, 670 Founders Square, 900 Jackson Street, Dallas, TX, 75202, US

(73) Assignee: International Business Machines Corporation, Armonk, NY (US)

(21) Appl. No.: 10/815,212

(22) Filed: Mar. 31, 2004

(51) Int. Cl. G01C 21/34

(52) U.S. Cl. 701/210; 701/213; 340/995.21

(57) ABSTRACT

A method, an apparatus, and a computer program are provided for dynamically routing traffic routs based on traffic reports. Utilizing current in-car navigation systems, a new implementation of that system can be developed where alternate routes can be plotted around varying traffic events. By receiving radio or Radio Frequency (RF) communications regarding current traffic conditions, the in-car navigation system can be modified to plot alternate routes. Also, the in-car navigation systems could utilize computer memory to develop histories of events so that reoccurring traffic events such as rush hour conditions can be avoided.

### FIELD OF THE INVENTION

The present invention relates generally to the real-time acquisition of traffic data and, more particularly, to acquisition of traffic data based on the use of Global Positioning System (GPS).

### DESCRIPTION OF THE RELATED ART

In automobiles and other vehicles, GPS units have become commonplace. The GPS system utilizes 24 satellites in varying orbits to transmit signals to GPS receivers. A GPS receiver receives a minimum of signals from 4 satellites to triangulate the relative position of the receiver in relation to the satellites. Then comparing that relative position to a map, the receiver can calculate the position on Earth.

GPS devices installed in automobiles and other vehicles, typically, do not simply calculate a longitude and latitude of the automobile or vehicle. The GPS device, with a GPS receiver included, usually have a number of other features. Further incorporated in the GPS receivers are varying programs, equipment, and databases to allow for real-time usage of the GPS data. For example, a route can be plotted to a destination. In fact, GPS devices have become so sophisticated as to provide turn-by-turn directions that will immediately warn a driver when a wrong turn is made.

With GPS devices that have plotting systems, a variety of different directions can be plotted. Paths based on the shortest routes, paths without using highways, paths only using highways, and so forth can be plotted. However, these directions do not take into account current accidents, construction events, weather delays, or other environmental conditions that can affect driving times.

Therefore, there is a need for a GPS system that accounts for environmental conditions in real-time that affect driving route that addresses at least some of the problems associated with conventional methods and apparatuses for plotting directions using the GPS system.

### SUMMARY OF THE INVENTION

The present invention provides a processing method and apparatus for navigation of a vehicle in which alternate routes are calculated utilizing GPS coordinates of traffic or environmental conditions.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a conventional GPS system for vehicles;

FIG. 2 is a block diagram depicting a GPS system that accounts for environmental conditions; and

FIG. 3A and FIG. 3B are flow charts depicting the operation of a GPS system that accounts for environmental conditions.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combinations thereof. In a preferred embodiment, however, the functions are performed by a processor such as a computer or an electronic data processor in accordance with code such as computer program code, software, and/or integrated circuits that are coded to perform such functions, unless indicated otherwise.

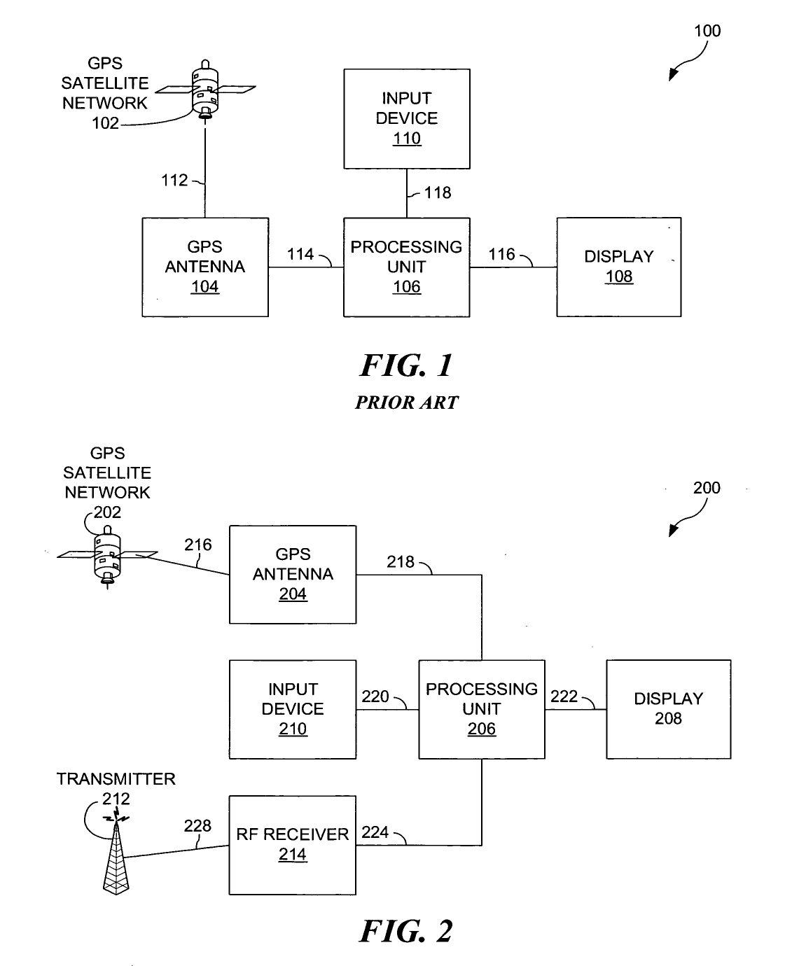

Referring to FIG. 1 of the drawings, the reference numeral 100 generally designates a conventional GPS system for vehicles. The system 100 comprises the GPS satellite network 102, a GPS antenna 104, a processing unit 106, an input device 110, and a display 108.

The system 100 functions through triangulating a relative position utilizing timing signals, relative displacement vectors, and relative velocity vectors. The GPS satellite network 102 transmits a number of signals to the GPS antenna 104 through a first communication channel 112. The GPS antenna 104 then provides the signals to the processing unit 106 through a second communication channel 114. The user or some other device can input a variety of other datum via an input device 110 to the processing unit 106 through a third communication channel 118. For example, a user can request that the processing unit plot directions to a location. The processing unit 106 then provides refined data to the display 108 through a fourth communication channel 116.

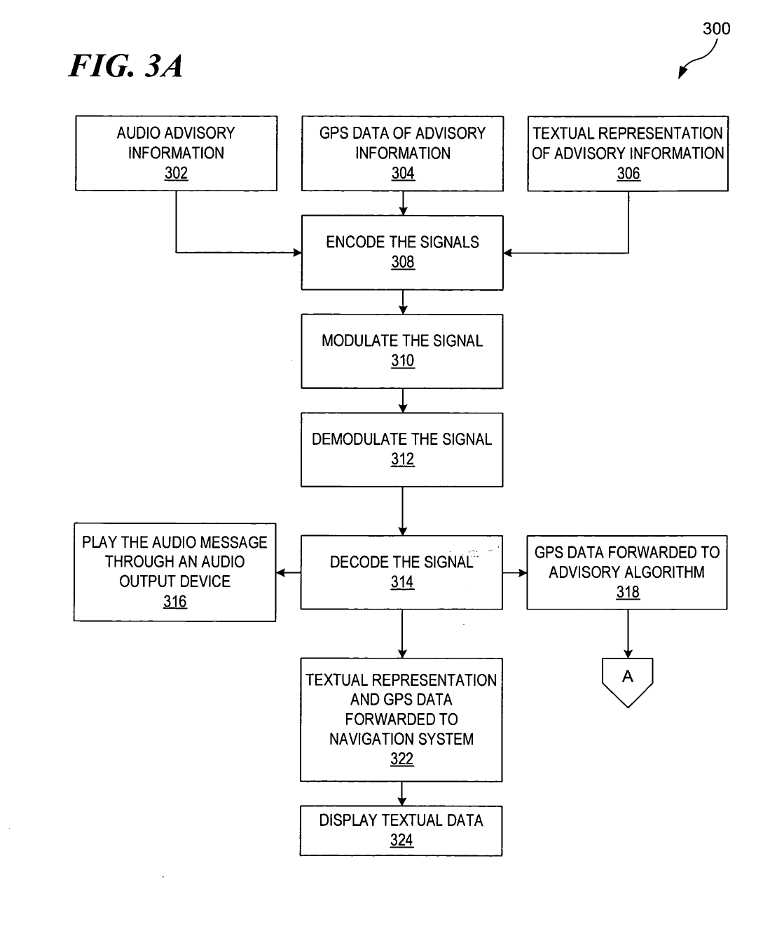

Referring to FIG. 2 of the drawings, the reference numeral 200 generally designates a GPS system that accounts for environmental conditions. The system 200 comprises the GPS satellite network 202, a GPS antenna 204, a processing unit 206, an input device 210, a transmitter 212, an RF receiver 214, and a display 208.

The system 200 functions through triangulating a relative position utilizing timing signals, relative displacement vectors, and relative velocity vectors. The GPS satellite network 202 transmits a number of signals to the GPS antenna 204 through a first communication channel 216. The GPS antenna 204 then provides the signals to the processing unit 206 through a second communication channel 218. The user or some other device can input a variety of other datum via an input device 210 to the processing unit 206 through a third communication channel 220. For example, a user may request that the processing unit plot directions to a location.

In the system 200, though, incorporates some other features. A transmitter 212 transmits advisory information to the Radio Frequency (RF) receiver through a fourth communication channel 228. The transmitter 212 can be a variety of types of transmitters including, but not limited to, cellular transmitters, Amplitude Modulation (AM) transmitters, Frequency Modulation (FM) transmitters, and satellite transmitters. Conversely, the RF receiver can be a variety of types receivers including, but not limited to, cellular receivers, AM receivers, FM receivers, and satellite receivers. The advisory information can include varying types of information including, but not limited to, audio information, textual information, and GPS information. Moreover, the advisory information is capable of providing data on current environmental conditions, such as traffic accidents, road conditions, weather, construction, and other delays. For example, if advisory information is transmitted through an AM transmitter, a driver can tune an AM radio receiver to the transmission frequency to receive the advisory data.

Once the advisory information has been received, the information can then be processed. The RF receiver 214 transmits the advisory data to the processing unit 206 through a fifth communication channel 224. The processing unit 206 can then decode the advisory information into its constituent information components, such as audio information, textual information, and GPS information. Based on the information received, the processing unit 206 can then compute alternate routes to a destination taking into account the current position calculated from the GPS data received from the GPS network 202 and the transmitter 212. Moreover, the processing unit can store and/or compile historical data regarding environmental conditions, for example traffic density at a specific time of day. The processing unit 206 then provides refined data to the display 208 through a sixth communication channel 222. The display can be a variety of types of displays including, but not limited to, a radio and a visual display. The refined data can include, but not limited to, audio, such as a radio broadcast, and visual data, such as graphical maps and textual information.

Also, there are several ways to employ such a system. The system can either operate passively or actively. For example a driver can actively tune a radio to a radio station that provides traffic information. Hence, once the radio is tuned to the proper station, then the process can begin receiving traffic data. Also, a specialized receiver can be employed. If a specialized receiver is employed, the system 200 would automatically receive traffic data.

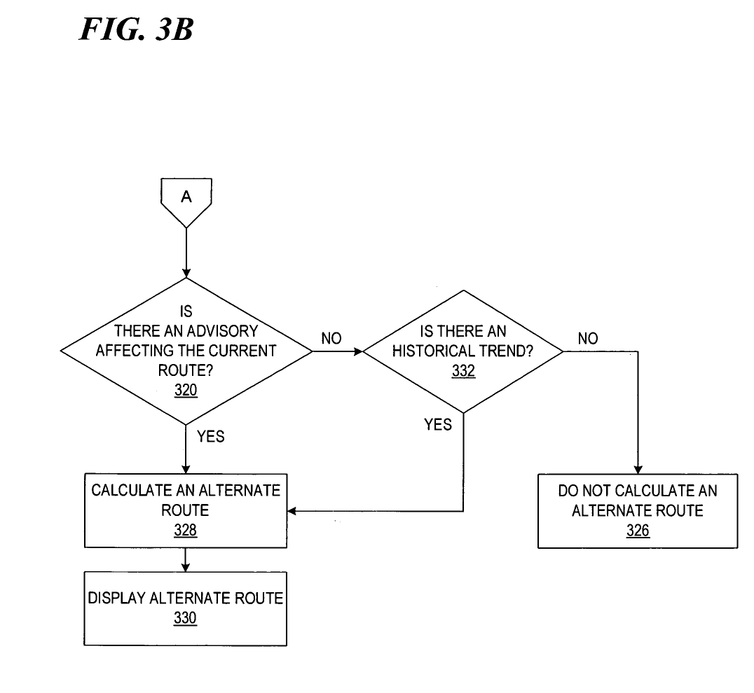

Referring to FIG. 3A and FIG. 3B of the drawings, the reference numeral 300 generally designates a flow chart depicting the operation of a GPS system that accounts for environmental conditions with accompanying audio information.

In steps 302, 304, and 306, the advisory information is encoded. Audio advisory 302, GPS data of advisory information 304, textual representations of advisory information 306, or any combination thereof can be encoded into a signal 308. Typically, these signals can be encoded for transmission over standard AM or FM radio frequencies, but there are a variety of other manners in which the signals can be encoded, such as encoded for transmission over a cellular system or satellite system.

In steps 310, 312, and 314, the encoded signal is transmitted and decoded. An encoded signal is first modulated and broadcasted 310. There are a variety of well-known manners in which to modulate RF signals. Once broadcasted, a vehicle receives and demodulates the encoded signal 312. Also, there are a variety of well-known manners in which to demodulate RF signals. Once demodulated, the encoded signal is decoded 314 into its constituent components including but not limited to, audio information, textual information, and GPS information.

In steps 316, 322 and 324, some of the data can be displayed without extensive processing. Audio messages can be broadcast to the user 316. The audio messages can use a variety of devices, for example an AM radio. Also, textual messages and GPS advisory data are forwarded to navigation system 322. From there, textual data regarding environmental conditions can be displayed.

Calculating alternate routes, though, requires more extensive processing and another set of steps. The GPS advisory data is forwarded to an advisory algorithm 318. The processing unit 206 of FIG. 2 then determines if there is an advisory affecting the current route 320 (FIG. 3B). If there is an advisory affecting the current route, then an alternate route is calculated 328 and is displayed 330. If there is not an advisory affecting the current route, then the processing unit 206 of FIG. 2 determines if there is a historical trend of problems or delays associated with the current route 332. If there is not a historical trend, then no alternate route is calculated 326. However, if there is a historical tend, then an alternate route is calculated 328 and is displayed 330.

It will further be understood from the foregoing description that various modifications and changes may be made in the preferred embodiment of the present invention without departing from its true spirit. This description is intended for purposes of illustration only and should not be construed in a limiting sense. The scope of this invention should be limited only by the language of the following claims.

1. An apparatus for navigating a vehicle, comprising:
a Global Positioning System (GPS) receiver, wherein the GPS receiver at least determines GPS coordinates of the vehicle;
a Radio Frequency (RF) receiver, wherein the RF receiver is at least configured to receive a plurality of RF signals, wherein the plurality of RF signals are at least configured to contain GPS coordinates of traffic or environmental conditions; and
a processing unit, wherein the processing unit is at least configured to receive the GPS coordinates of the vehicle, to receive the GPS coordinates of traffic conditions or environmental conditions and to calculate alternate routes of vehicle travel around the traffic or environmental conditions.

2. The apparatus of claim 1, wherein the RF receiver is an Amplitude Modulation (AM) Radio receiver, a Frequency Modulation (FM) Radio receiver, a cellular receiver, or a satellite receiver.

3. The apparatus of claim 2, wherein the processing unit further comprises:
a decoder, wherein the decoder decodes the plurality of RF signals into a plurality of constituent data streams, wherein at least one data stream is the GPS coordinates of traffic or environmental conditions; and
a navigation unit, wherein the navigation unit calculates alternate routes based on the GPS coordinates of the traffic or environmental conditions and the GPS coordinates of the vehicle.

4. The apparatus of claim 3, wherein the processing unit further comprises:
a storage unit, wherein the storage unit at least stores a time of day of the traffic or environmental conditions, the GPS coordinates of the traffic or environmental conditions, and a date of the traffic or environmental conditions; and
a correlation unit, wherein the correlation unit is at least configured to determine historical trends of the traffic or environmental conditions based on the time of day of the traffic or environmental conditions, the GPS coordinates of the traffic or environmental conditions, and the date of the traffic or environmental conditions.

5. The apparatus of claim 1, wherein the processing unit further comprises:
a storage unit, wherein the storage unit at least stores a time of day of the traffic or environmental conditions, the GPS coordinates of the traffic or environmental conditions, and a date of the traffic or environmental conditions; and
a correlation unit, wherein the correlation unit is at least configured to determine historical trends of the traffic or environmental conditions based on the time of day of the traffic or environmental conditions, the GPS coordinates of the traffic or environmental conditions, and the date of the traffic or environmental conditions.

6. A method for navigating a vehicle, comprising:
receiving GPS coordinates of the vehicle;
receiving a plurality of RF signals;
decoding the plurality of RF signal into a plurality of constituent data streams, wherein at least one constituent data stream at least comprises traffic or environmental conditions; and
plotting alternate routes based at least on the GPS coordinates of the vehicle and the traffic or environmental conditions.

7. The method of claim 6, wherein step of receiving a plurality of RF signals further comprises at least receiving AM Radio signals, FM Radio signals, cellular signals, or satellite signals.

8. The method of claim 7, wherein the method further comprises:
at least storing a time of day of the traffic or environmental conditions;
at least storing the GPS coordinates of the traffic or environmental conditions;
at least storing a date of the traffic or environmental conditions; and
determining historical trends of the traffic or environmental conditions base on the time of day of the traffic or environmental conditions, the GPS coordinates of the traffic or environmental conditions, and the date of the traffic or environmental conditions.

9. The method of claim 6, wherein the method further comprises:
at least storing a time of day of the traffic or environmental conditions;
at least storing the GPS coordinates of the traffic or environmental conditions;
at least storing a date of the traffic or environmental conditions; and
determining historical trends of the traffic or environmental conditions base on the time of day of the traffic or environmental conditions, the GPS coordinates of the traffic or environmental conditions, and the date of the traffic or environmental conditions.

10. A computer program product for navigating a vehicle in a computer system, the computer program product having a medium with a computer program embodied thereon, the computer program comprising:
computer code for receiving GPS coordinates of the vehicle;
computer code for receiving a plurality of RF signals;
computer code for decoding the plurality of RF signal into a plurality of constituent data streams, wherein at least one constituent data stream at least comprises traffic or environmental conditions; and
computer code for plotting alternate routes based at least on the GPS coordinates of the vehicle and the traffic or environmental conditions.

11. The computer program product of claim 10, wherein computer code for receiving a plurality of RF signals further comprises at least a computer code for receiving AM Radio signals, FM Radio signals, cellular signals, or satellite signals.

12. The computer program product of claim 11, wherein the computer program product further comprises:
computer code for storing a time of day of the traffic or environmental conditions;
computer code for storing the GPS coordinates of the traffic or environmental conditions;
computer code for storing a date of the traffic or environmental conditions; and
computer code for determining historical trends of the traffic or environmental conditions base on the time of day of the traffic or environmental conditions, the GPS coordinates of the traffic or environmental conditions, and the date of the traffic or environmental conditions.

13. The computer program product of claim 10, wherein the computer program product further comprises:
computer code for storing a time of day of the traffic or environmental conditions;
computer code for storing the GPS coordinates of the traffic or environmental conditions;
computer code for storing a date of the traffic or environmental conditions; and
computer code for determining historical trends of the traffic or environmental conditions base on the time of day of the traffic or environmental conditions, the GPS coordinates of the traffic or environmental conditions, and the date of the traffic or environmental conditions.

14. A processing unit for navigating a vehicle comprising at least being configured to calculate alternate routes, wherein GPS coordinates of traffic or environmental conditions and GPS coordinates of the vehicle are at least utilized.

15. The processing unit of claim 14, wherein the processing unit is at least configured to utilize an AM Radio receiver, a FM Radio receiver, a cellular receiver, or a satellite receiver for at least receiving the traffic and environmental conditions.

16. The processing unit of claim 15, wherein the processing unit further comprises:
a decoder, wherein the decoder decodes a plurality of RF signals into a plurality of constituent data streams, wherein at least one data stream is the GPS coordinates of traffic or environmental conditions; and
a navigation unit, wherein the navigation unit calculates alternate routes based on the GPS coordinates of the traffic or environmental conditions and the GPS coordinates of the vehicle.

17. The processing unit of claim 16, wherein the processing unit further comprises:
a storage unit, wherein the storage unit at least stores a time of day of the traffic or environmental conditions, the GPS coordinates of the traffic or environmental conditions, and a date of the traffic or environmental conditions; and
a correlation unit, wherein the correlation unit is at least configured to determine historical trends of the traffic or environmental conditions based on the time of day of the traffic or environmental conditions, the GPS coordinates of the traffic or environmental conditions, and the date of the traffic or environmental conditions.

18. The processing unit of claim 14, wherein the processing unit further comprises:
a storage unit, wherein the storage unit at least stores a time of day of the traffic or environmental conditions, the GPS coordinates of the traffic or environmental conditions, and a date of the traffic or environmental conditions; and
a correlation unit, wherein the correlation unit is at least configured to determine historical trends of the traffic or environmental conditions based on the time of day of the traffic or environmental conditions, the GPS coordinates of the traffic or environmental conditions, and the date of the traffic or environmental conditions.
